(19) United States
(12) Patent Application Publication
(10) Pub. No.: US 2011/0298762 A1
(43) Pub. Date: Dec. 8, 2011

(54) Driving Device, Driving Method and Portable Electronic Display Device

(76) Inventor: Shu-Yi Lin, New Taipei City (TW)

(21) Appl. No.: 13/092,121

(22) Filed: Apr. 21, 2011

(30) Foreign Application Priority Data
Jun. 2, 2010 (TW) 099117832

(51) Int. Cl. G06F 3/038

(52) U.S. Cl. 345/204; 345/84

(57) ABSTRACT

A driving device for a portable electronic display device for showing a digital content includes a movement sensor installed in the portable electronic display device, for detecting a rotating status of the portable electronic display device to generate a detecting result, and a control module for switching to display a plurality of pages of the digital content according to the detecting result.

### BACKGROUND OF THE INVENTION

1. Field of the Invention

The present invention relates to a driving device, driving method and portable electronic display device, and more particularly, to a driving device, driving method and portable electronic display device utilizing rotating movements identical or similar to flipping pages, to control an electronic book to switch pages, such that operations of the electronic book are similar to conventional reading styles, so as to boost user's intention to use.

2. Description of the Prior Art

An electronic book is a portable electronic display device similar to a book, and utilized for showing a digitalized book content. In general, a weight and a size of an electronic book are suitable for hand-held operations, such that a user can read anytime and anywhere.

For example, FIG. 1 is a schematic diagram of a conventional electronic book 10. In the electronic book 10, a display panel 100 is utilized for showing a digitalized book content, and keypads 102, 104 are utilized for controlling “previous page”, “next page” operations. In other words, when a user uses the electronic book 10 to read texts or pictures, the user can switch images displayed by the panel 100 via the keypads 102, 104. However, such kind of operation does not conform to conventional reading styles, and limits user's intention to use the electronic book 10.

Conventionally, people read books by flipping pages with hands, and flip pages to and fro to look up contents in former and latter pages. Therefore, if a method of controlling the electronic book to switch pages can be achieved by conventional movements of flipping pages, the method becomes more similar to conventional reading styles, and thus suitable for people unfamiliar with complex operating styles of electronic products or children, so as to boost user's intention to use.

### SUMMARY OF THE INVENTION

It is therefore, an objective of the present invention to provide a driving device, driving method and portable electronic display device.

The present invention discloses a driving device for a portable electronic display device capable of showing a digital content. The driving device includes a movement sensor, installed in the portable electronic display device, for detecting a rotating status of the portable electronic display device, to generate a detecting result, and a control module, for switching to display a plurality of pages of the digital content according to the detecting result.

The present invention further discloses a portable electronic display device capable of showing a digital content. The portable electronic display device includes a panel, an image processing unit, for showing the digital content via the panel, and a driving device. The driving device includes a movement sensor, for detecting a rotating status of the portable electronic display device, to generate a detecting result, and a control module, for controlling the image processing unit to switch to display a plurality of pages of the digital content according to the detecting result.

The present invention further discloses a portable electronic display device capable of showing a digital content. The portable electronic display device includes a first panel, a second panel, installed in a back of the first panel, an image processing unit, for showing the digital content via the first panel and the second panel, and a driving device. The driving device includes a movement sensor, for detecting a rotating status of the portable electronic display device, to generate a detecting result, and a control module, for controlling the image processing unit to switch to display a plurality of pages of the digital content according to the detecting result.

The present invention further discloses a driving method for a portable electronic display device capable of showing a digital content. The driving method includes steps of detecting a rotating status of the portable electronic display device, to generate a detecting result, and switching to display a plurality of pages of the digital content according to the detecting result.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a conventional electronic book.

FIG. 2 is a schematic diagram of a driving device according to an embodiment of the present invention.

FIG. 3A and FIG. 3B are schematic diagrams of appearance and functions of a portable electronic display device according to an embodiment of the present invention.

FIG. 3C is a schematic diagram of operations of a driving device in FIG. 3B.

FIG. 3D is another schematic diagram of operations of the driving device in FIG. 3B.

FIG. 4A and FIG. 4B are schematic diagrams of appearance and functions of a portable electronic display device according to another embodiment of the present invention.

FIG. 4C is a schematic diagram of operations of a driving device in FIG. 4B.

FIG. 5A and FIG. 5B are schematic diagrams of appearance and functions of a portable electronic display device according to another embodiment of the present invention.

FIG. 5C is a schematic diagram of operations of a driving device in FIG. 5B.

FIG. 6A and FIG. 6B are schematic diagrams of appearance and functions of a portable electronic display device according to another embodiment of the present invention.

FIG. 6C is a schematic diagram of operations of a driving device in FIG. 6B.

FIG. 6D and FIG. 6E are schematic diagrams of deflecting statuses of the portable electronic display device in FIG. 6A.

FIG. 7 is a schematic diagram of a driving process according to an embodiment of the present invention.

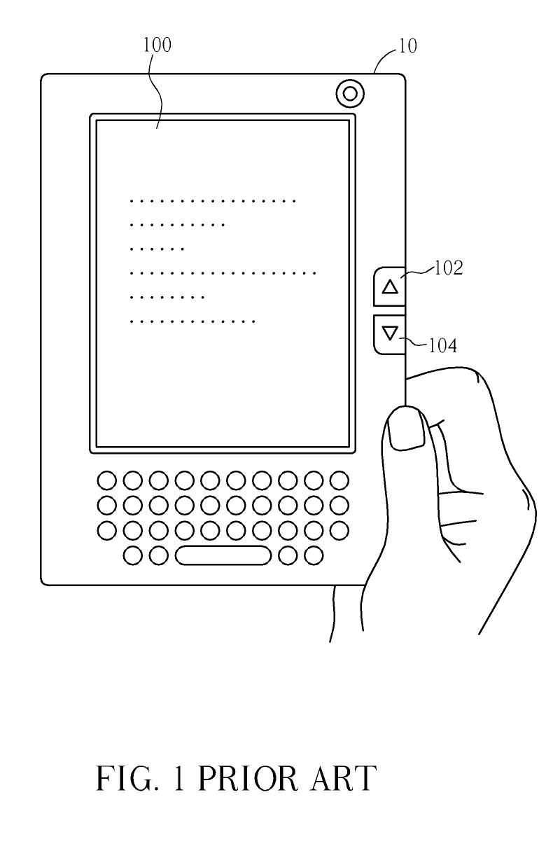

### DETAILED DESCRIPTION

A feature of conventional reading styles when flipping pages is that the flipped pages are rotated (and deformed) accordingly. A main reason why operations of the conventional electronic book do not conform to the conventional reading styles is that the electronic book shows a book content via a same plane display, and thus cannot be flipped like paper. In such a situation, the present invention utilizes rotating movements identical or similar to flipping pages to control an electronic book to switch pages, such that operations of the electronic book are similar to conventional reading styles.

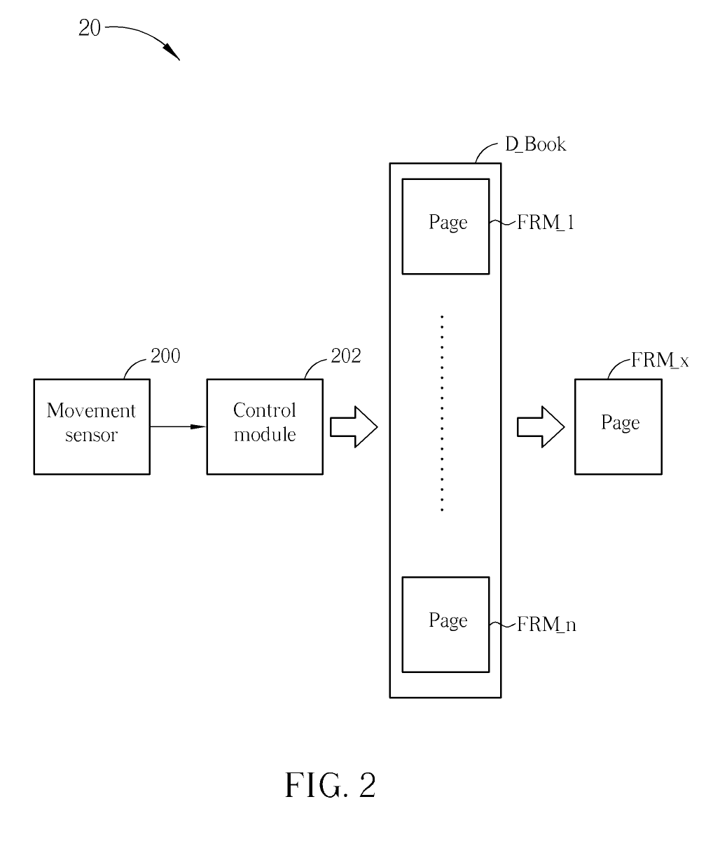

Please refer to FIG. 2, which is a schematic diagram of a driving device 20 according to an embodiment of the present invention. The driving device 20 is utilized for displaying digital content D_Book in a portable electronic display device, such as an electronic book, an electronic paper, a tablet computer. The digital content D_Book can be digitalized books, magazines, photographs, and includes pages FRM_1˜FRM_n. The driving device 20 includes a movement sensor 200 and a control module 202. According to a type of the applied portable electronic display device or supported functions, the movement sensor 200 can be a gravitation sensor, a deformation sensor, etc., for detecting a rotating status of the portable electronic display device. The control module 202 switches to display one page FRM_x among the pages FRM_1˜FRM_n according to a detecting result generated by the movement sensor 200.

In a word, after the driving device 20 is installed in the portable electronic display device, a user does not need to press keypads to control the portable electronic display device, and only needs to properly rotate the portable electronic display device in a specific manner, so as to switch to display the pages FRM_1˜FRM_n of the digital content D_Book. In such a situation, operations of the electronic book are similar to conventional reading styles, so as to boost user's intention to use.

Noticeably, the driving device 20 can be installed in any portable electronic display device, to replace or coexist with keypad-based devices for switching pages. Besides, designers should further adjust components or operating logics of the driving device 20 by utilizing characteristics or functions of different portable electronic display devices.

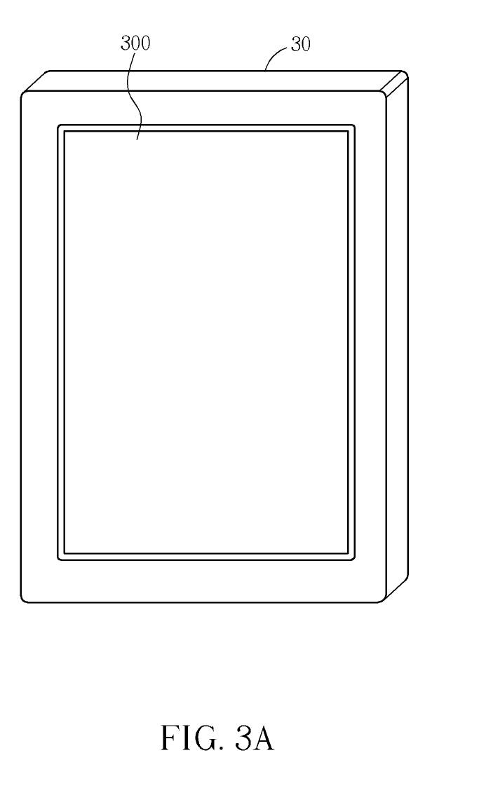

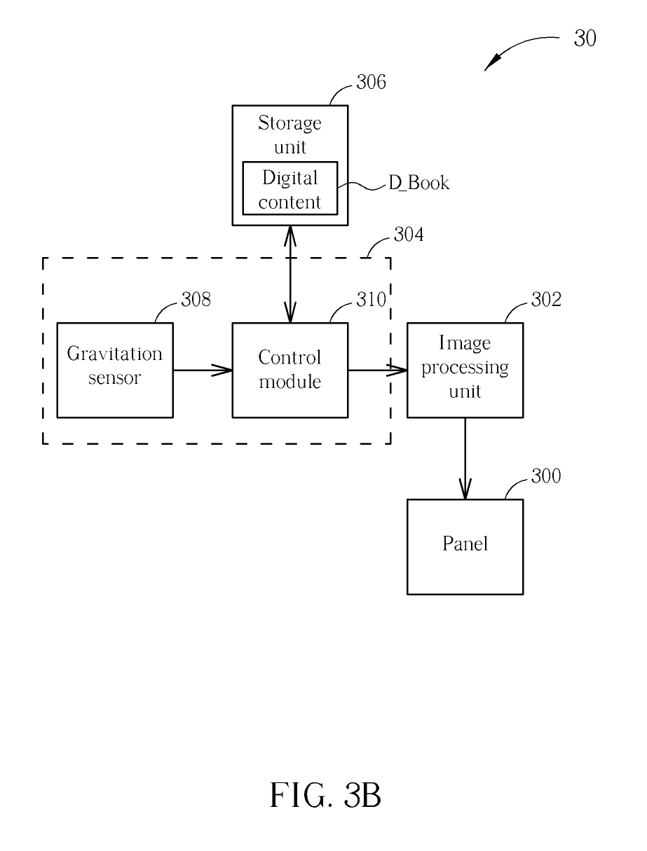

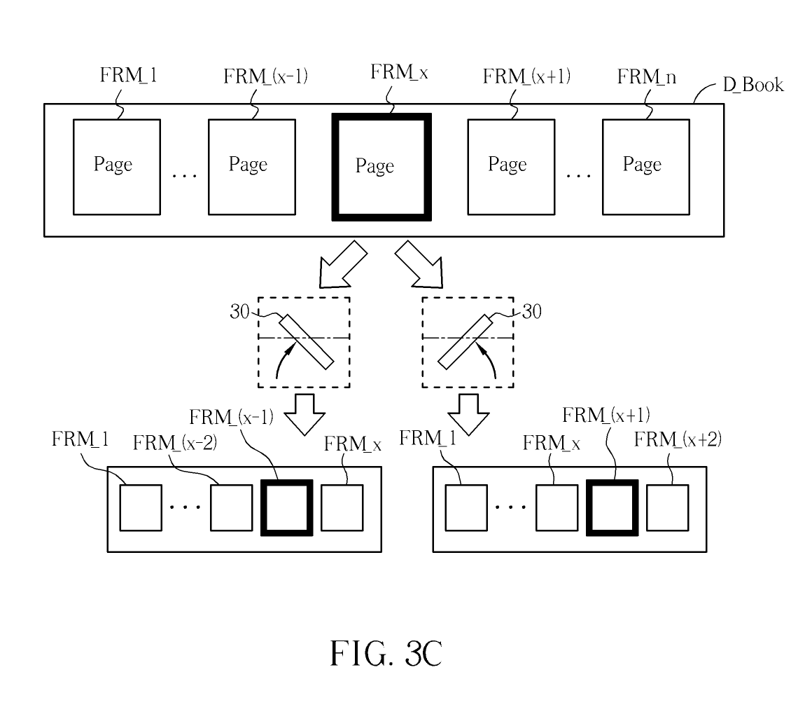

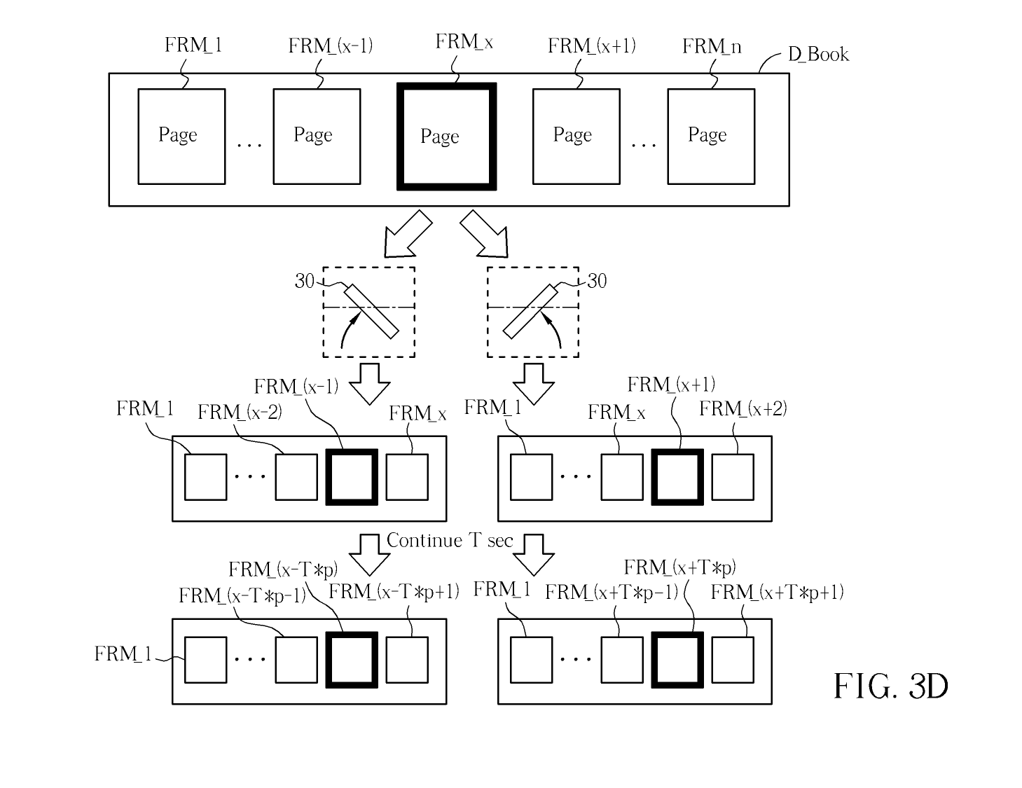

For example, please refer to FIG. 3A and FIG. 3B, which are schematic diagrams of appearance and functions of a portable electronic display device 30 according to an embodiment of the present invention. The portable electronic display device 30 includes a panel 300, an image processing unit 302, a driving device 304 and a storage unit 306. The storage unit 306 stores the digital content D_Book. Operating principles of the driving device 304 are the same with those of the driving device 20 in FIG. 2, i.e. a control module 310 controls the image processing unit 302 to switch to display the pages FRM_1˜FRM_n of the digital content D_Book according to a rotating status of the portable electronic display device 30. However, differences between the driving device 304 and the driving device 20 are that the driving device 304 realizes the movement sensor 200 of the driving device 20 by a gravitation sensor 308. The gravitation sensor 308 can detect information of the portable electronic display device 30, such as an angle of inclination, a speed, a displacement, and thus can be utilized for realizing a movement sensor, to detect the rotating status of the portable electronic display device 30.

After the gravitation sensor 308 determines the rotating status of the portable electronic display device 30, the control module 310 switches pages accordingly. Related operations of the control module 310 are illustrated in FIG. 3C. In FIG. 3C, assume that an image displayed by the panel 300 is the page FRM_x, if the gravitation sensor 308 detects the portable electronic display device 30 rotating clockwise, the control module 310 controls the image processing unit 302 to switch the image displayed by the panel 300 from the page FRM_x to a page FRM_(x−1) as shown in a left part of FIG. 3C. On the other hand, if the gravitation sensor 308 detects the portable electronic display device 30 rotating counterclockwise, the control module 310 controls the image processing unit 302 switches the image displayed by the panel 300 from the page FRM_x to the page FRM_(x+1) as shown in a right part of FIG. 3C.

Noticeably, FIG. 3C is only utilized for illustrating basic operations of the driving device 304, and those skilled in the art should make modifications and alterations accordingly, which are not limited to this. For example, a threshold mechanism can be introduced into the gravitation sensor 308, i.e. a rotating angle of the portable electronic display device 30 is divided into multiple regions, e.g. 0˜15°, 15°˜30′, etc. When the rotating angle of the portable electronic display device 30 is more than a first region (i.e. 15°), a related detecting result is outputted accordingly. Certainly, such a threshold mechanism can be realized in the control module 310 as well. In other words, the gravitation sensor 308 can continue to output the gravitation detecting result of the portable electronic display device 30 (equivalent to the rotating status), and the control module 310 controls the image processing unit 302 to switch the image displayed by the panel 300 to a different page FRM_x only when a detecting result of the gravitation sensor 308 indicates the portable electronic display device 30 rotating more than a specific angle.

Furthermore, a multiple-page switching mechanism can be introduced into the control module 310 as well. In other words, if the user continues to maintain the portable electronic display device 30 at a same rotating angle, as time goes by, the control module 310 can switch multiple pages at one time, so as to increase a switch speed. For example, FIG. 3D is an example derived from FIG. 3C, if the portable electronic display device 30 is maintained at the same rotating angle, which continues T sec, switched pages controlled by the control module 310 are T*p pages, whereas p denotes switched page per sec and can be a fixed number, an equation, etc. For example, three equations for T regions are as follows:

p=1, T<5

p=2, 5≦T<8

p=3, 8≦T.

In such a situation, if the portable electronic display device 30 is maintained at the same rotating angle less than 5 sec, the control module 310 switches 1 page per sec; if the portable electronic display device 30 is maintained at the same rotating angle more than or equal to 5 sec and less than 8 sec, the control module 310 switches 2 pages per sec; and if the portable electronic display device 30 is maintained at the same rotating angle more than or equal to 8 sec, the control module 310 switches 3 pages per sec. Certainly, the above description is only an embodiment of the present invention, designers should make proper modifications or alterations according to system requirements, to realize different switch speeds or logics.

Besides, the above description does not mention how to stop switching pages, which should readily be derived by those skilled in the art. For example, when the rotating angle of the portable electronic display device 30 is back to a horizontal plane, operations of switching pages can be stopped. In addition, in order to prevent switching pages due to false determination, an extra keypad or control button can be added, for activating or stopping operations of the driving device 304, to prevent affecting the user reading.

Noticeably, the above description also defines an order of the pages FRM_1˜FRM_n of the digital content D_Book. In other words, a method of arranging the pages FRM_1˜FRM_n from left to right in FIG. 3C or FIG. 3D is only utilized for illustrating the concept of the present invention. Since digital contents with different languages, texts, contents may have different switching styles. For example, a Chinese book can adopt a western writing style from left to right, and can adopt a vertical writing style from right to left, where the two writing styles have different switching styles. Therefore, the order of the pages FRM_1˜FRM_n of the above description is only for simplicity, and is not related to contents. In other words, the page FRM_n may denote a first page of a book, while the page FRM_1 may denote a last page in the arranged order.

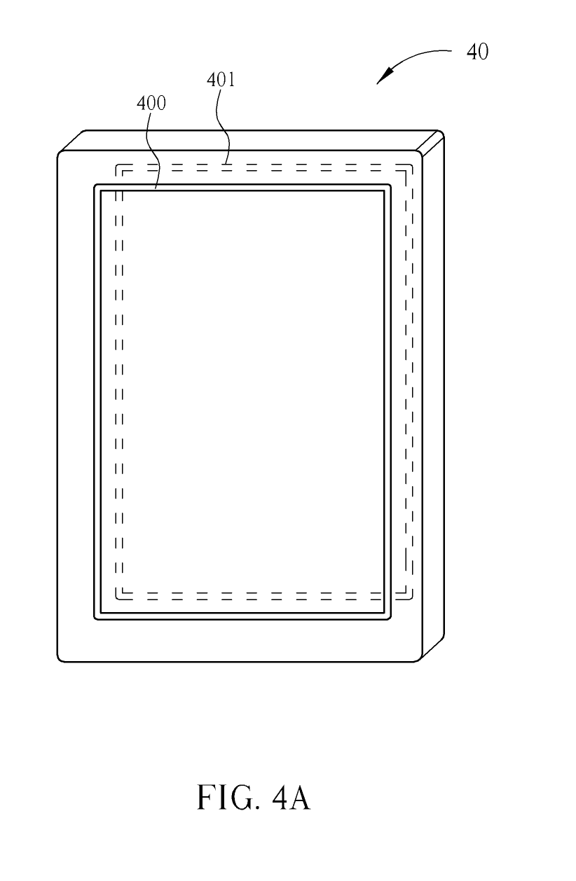

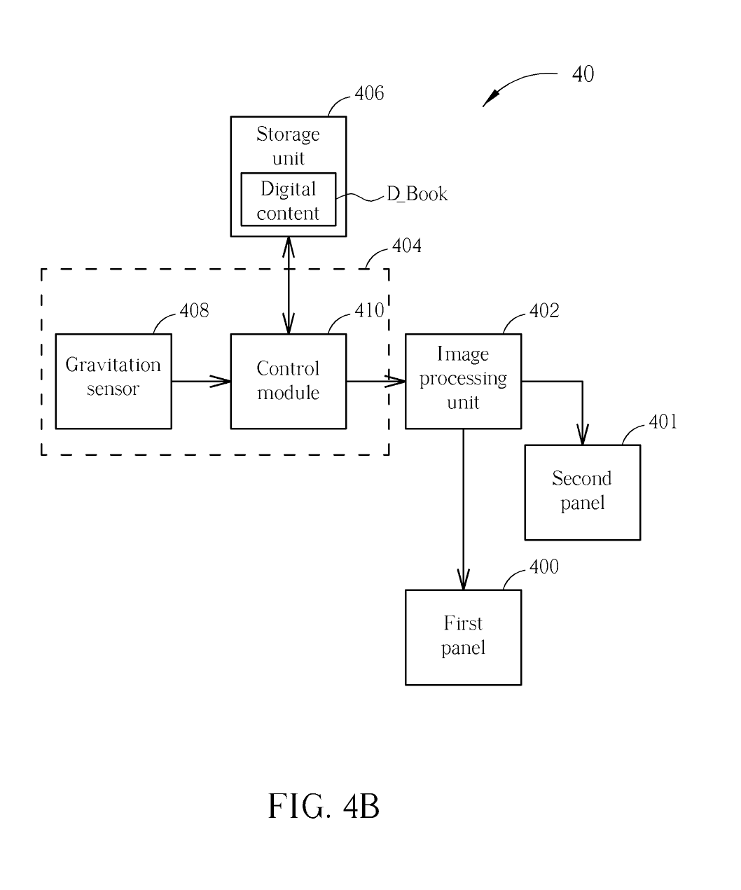

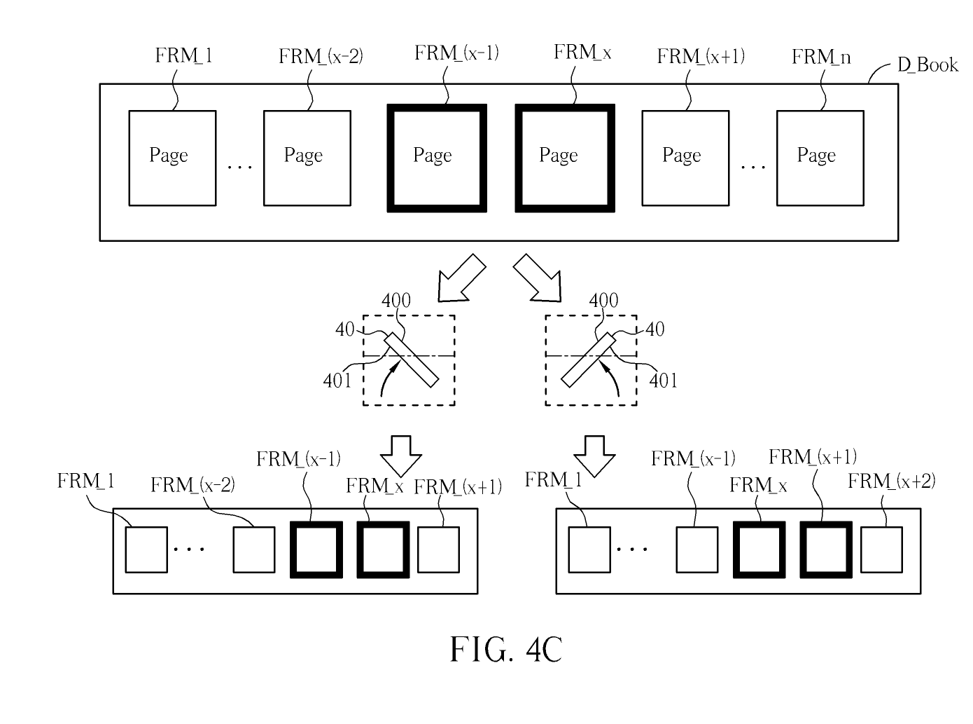

FIG. 3A to FIG. 3D are utilized for illustrating examples of the driving device 20 of the present invention applied in the portable electronic display device 30 with a single panel. Moreover, the concept of the present invention can be applied in a portable electronic display device with two panels. Please refer to FIG. 4A and FIG. 4B, which are schematic diagrams of appearance and functions of a portable electronic display device 40 according to an embodiment of the present invention. The portable electronic display device 40 includes a first panel 400, a second panel 401, an image processing unit 402, a driving device 404 and a storage unit 406. The storage unit 406 stores the digital content D_Book, and operating principles of the driving device 404 are the same with those of the driving device 304 in FIG. 3, i.e. a gravitation sensor 408 detects a rotating status of the portable electronic display device 40, and a control module 410 controls the image processing unit 402, to switch to display the pages FRM_1˜FRM_n of the digital content D_Book. However, differences between the driving device 404 and the driving device 304 are that the portable electronic display device 40 includes the first panel 400 and the second panel 401, which can simultaneously display two consecutive pages. Therefore, operating logics of the driving device 404 is slightly different from that of the driving device 304.

Please continue to refer to FIG. 4C, which is a schematic diagram of operations of the driving device 404. In FIG. 4C, assume that the first panel 400 faces upward, and an image displayed by the first panel 400 is the page FRM_x, while the second panel 401 faces downward, and an image displayed by the second panel 401 is the page FRM_(x−1). If the gravitation sensor 408 detects the portable electronic display device 40 rotating 180° clockwise (i.e. the first panel 400 becomes facing downward, while the second panel 401 becomes facing upward), since the page FRM_(x−1) is prior to the page FRM_x in this example, the control module 410 does not need to switch images displayed by the first panel 400 or the second panel 401 as shown in a left part of FIG. 4C. On the other hand, if the gravitation sensor 408 detects the portable electronic display device 40 rotating counterclockwise, the control module 410 can control the image processing unit 402 to switch the image displayed by the second panel 401 from the page FRM_(x−1) to a page FRM_(x+1) as shown in a right part of FIG. 4C.

As can be seen from the above, since the portable electronic display device 40 includes the first panel 400 and the second panel 401, when the portable electronic display device 40 rotates, the control module 410 does not need to switch the images displayed by the first panel 400 or the second panel 401. In addition, other modifications or alterations suitable for the driving device 304, such as a threshold mechanism in a gravitation sensor, a multiple-page switching mechanism in a control module, can be applied in the driving device 404 as well. Detailed realization can be referred to the above description, and is not narrated hereinafter.

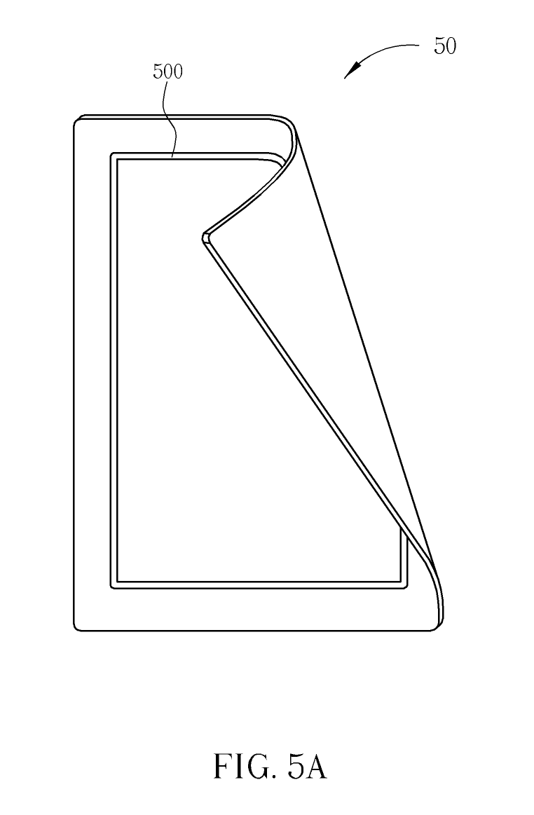

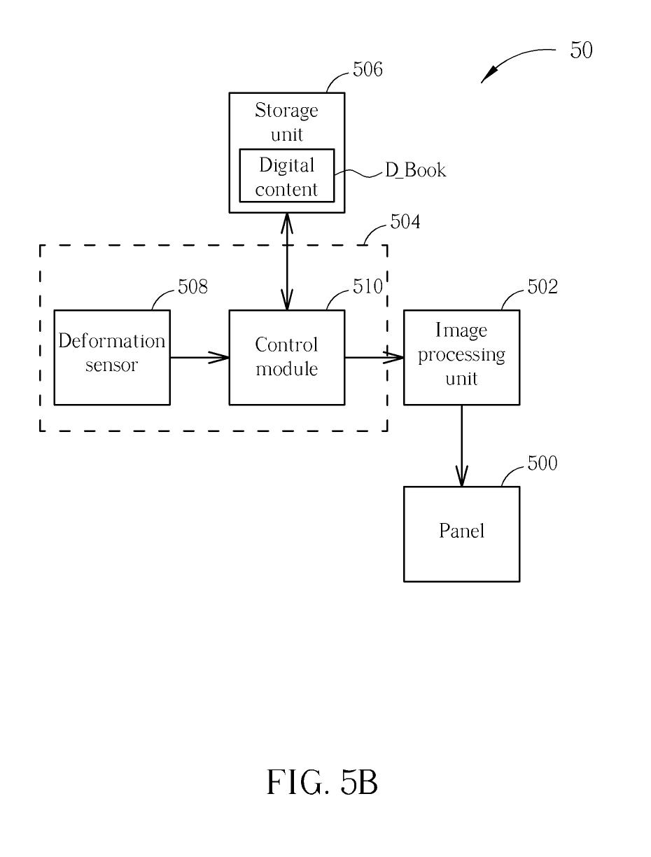

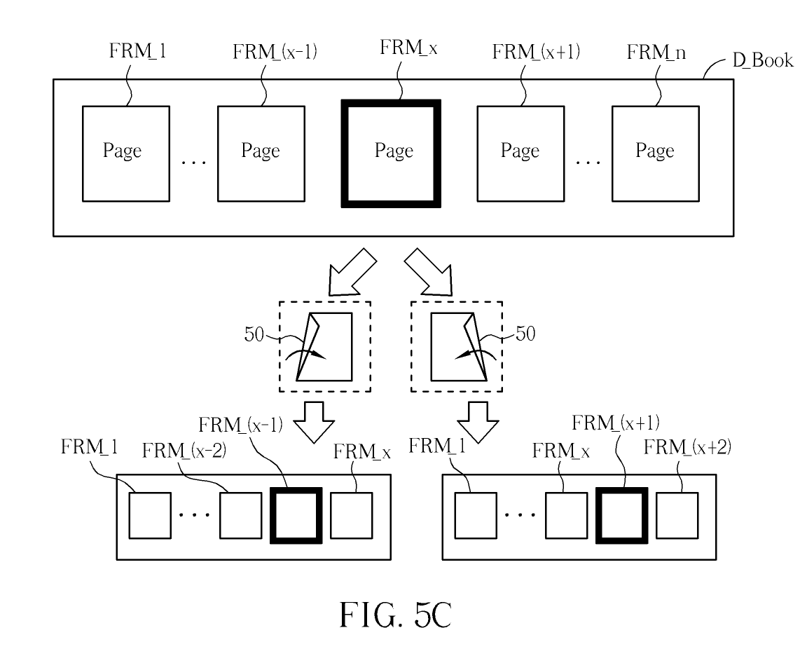

Other than utilizing the gravitation sensor to realize the movement sensor 200 in FIG. 2, for a portable electronic display device utilizing an electronic paper as a panel, since the electronic paper is flexible, the movement sensor 200 can be realized by a deformation sensor as well. Please refer to FIG. 5A and FIG. 5B, which are schematic diagrams of appearance and functions of a portable electronic display device 50 according to an embodiment of the present invention. The portable electronic display device 50 includes a panel 500, an image processing unit 502, a driving device 504 and a storage unit 506. The panel 500 is a flexible panel, such as an organic light emitting diode (OLED) panel. The storage unit 506 stores the digital content D_Book, and operating principles of the driving device 504 are the same with those of the driving device 20 in FIG. 2, i.e. a control module 510 controls the image processing unit 502 to switch to display the pages FRM_1˜FRM_n of the digital content D_Book according to a rotating status of the portable electronic display device 50. However, differences between the driving device 504 and the driving device 20 are that the driving device 504 realizes the movement sensor 200 of the driving device 20 by a deformation sensor 508. The deformation sensor 508 can detect a deflecting status of the panel 500, and thus can be utilized for realizing a movement sensor, to detect the rotating status of the portable electronic display device 50.

After the deformation sensor 508 determines the deflecting status of the panel 500, the control module 510 switches pages accordingly. Related operations of the control module 510 are illustrated in FIG. 5C. In FIG. 5C, assume that an image shown by the panel 500 is the page FRM_x, if the deformation sensor 508 detects the panel 500 deflecting rightward, the control module 510 can control the image processing unit 502 to switch the image displayed by the panel 500 from the page FRM_x to the page FRM_(x−1) as shown in a left part of FIG. 5C. On the other hand, if the deformation sensor 508 detects the panel 500 deflecting leftward, the control module 510 can control the image processing unit 502 to switch the image displayed by the panel 500 from the page FRM_x to the page FRM_(x+1) as shown a right part of FIG. 5C.

By comparing FIG. 5C with FIG. 3C, operations of the driving device 504 are similar to those of the driving device 304. Therefore, modifications or alterations for the driving device 304, such as a threshold mechanism in a deformation sensor, a multiple-page switching mechanism in a control module, can be applied in the driving device 504 after proper adjustment. Such corresponding modifications or alterations should be well known by those skilled in the art, and are not narrated hereinafter. Moreover, install location, realization, etc. of the deformation sensor 508 are not the subject matter of the present invention, and those devices capable of detecting the deflecting status of the panel 500 can be used in the present invention.

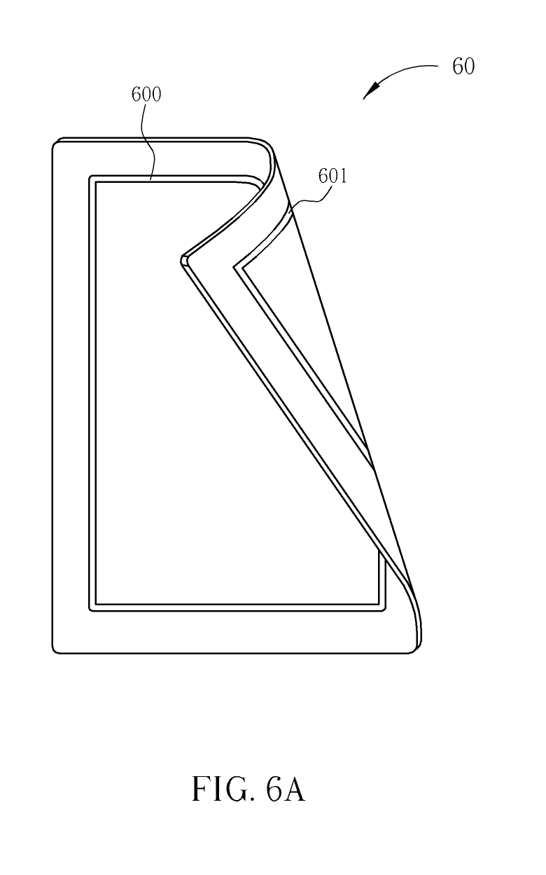

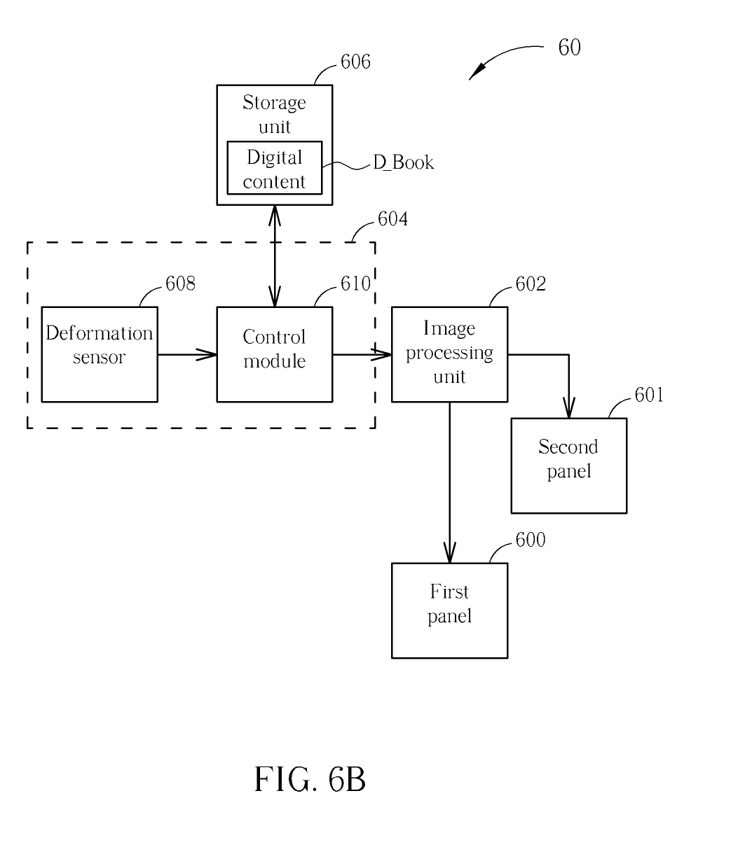

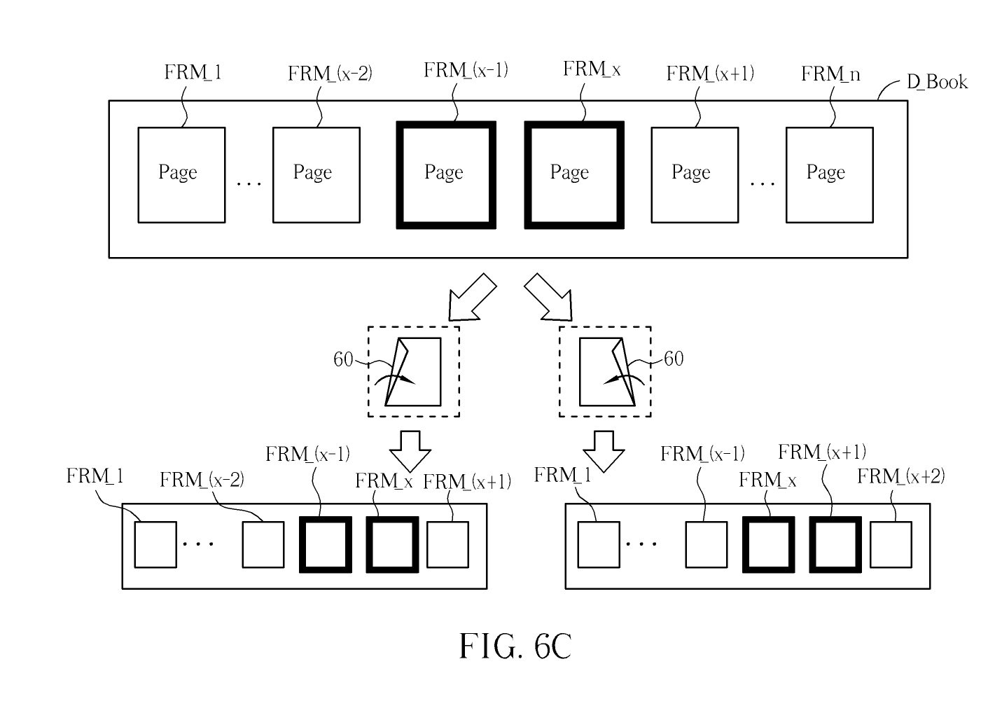

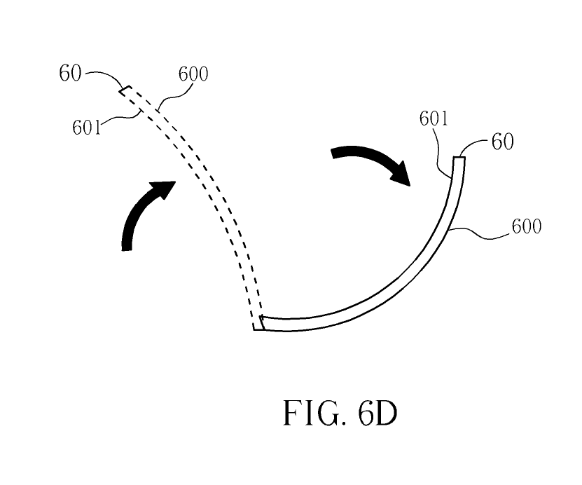

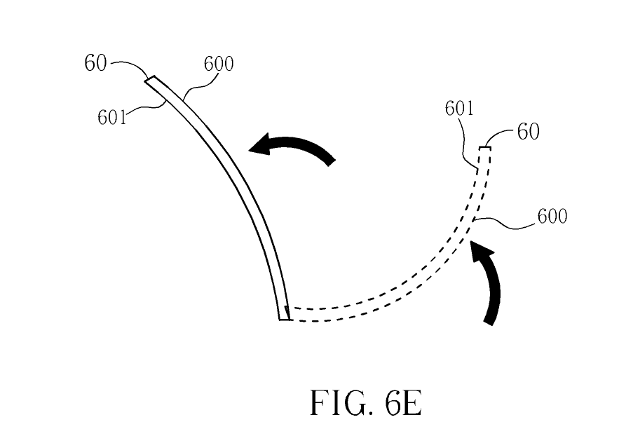

Similar to a relation between the portable electronic display device 40 and the portable electronic display device 30, the concept of the portable electronic display device 50 can be derived to a portable electronic display device with two flexible panels. Please refer to FIG. 6A and FIG. 6B, which are schematic diagrams of appearance and functions of a portable electronic display device 60 according to an embodiment of the present invention. The portable electronic display device 60 includes a first panel 600, a second panel 601, an image processing unit 602, a driving device 604 and a storage unit 606. Both the first panel 600 and the second panel 601 are flexible panels, such as OLED panels. The storage unit 606 stores the digital content D_Book, and operating principles of the driving device 604 are the same with those of the driving device 504 in FIG. 5, i.e. a deformation sensor 608 detects deflecting statuses of the first panel 600 and the second panel 601, and a control module 610 controls the image processing unit 602 to switch to display the pages FRM_1˜FRM_n of the digital content D_Book. However, differences between the driving device 604 and the driving device 504 are that the portable electronic display device 60 includes the first panel 600 and the second panel 601, which can simultaneously show two consecutive pages. Therefore, operating logics of the driving device 604 are slightly different from those of the driving device 504.

Please continue to refer to FIG. 6C, which is a schematic diagram of operations of the driving device 604. In FIG. 6C, assume that the first panel 600 faces upward, and an image displayed by the first panel 600 is the page FRM_x, and the second panel 601 faces downward, and an image displayed by the second panel 601 is the page FRM_(x−1). If the deformation sensor 608 detects the portable electronic display device 60 deflecting 180° rightward (i.e. the first panel 600 becomes facing faces downward, and the second panel 601 becomes facing upward), since the page FRM_(x−1) is prior to the page FRM_x in this example, the control module 610 does not need to switch images displayed by the first panel 600 or the second panel 601 as shown in a left part of FIG. 6C. On the other hand, if the deformation sensor 608 detects the portable electronic display device 60 deflecting leftward, the control module 610 can control the image processing unit 602 to switch the image displayed by the second panel 601 from the page FRM_(x−1) to the page FRM_(x+1) as shown in a right part of FIG. 6C.

As can be seen from the above, since the portable electronic display device 60 includes the first panel 600 and the second panel 601, when the portable electronic display device 60 deflects, the control module 610 does not need to switch the images displayed by the first panel 600 or the second panel 601. In addition, other modifications or alterations suitable for the driving device 504, such as a threshold mechanism in a deformation sensor, a multiple-page switching mechanism in a control module, can be applied in the driving device 604 as well. Detailed realization can be referred to the above description, and is not narrated hereinafter.

Noticeably, an identical deflecting status of the first panel 600 or the second panel 601 may correspond to two switching styles. For example, both FIG. 6D and FIG. 6E indicate flipping from the first panel 600 to the second panel 601. However, FIG. 6D indicates deflecting from left to right, i.e. switching to a previous page for the writing style from left to right; on the other hand, FIG. 6E indicates deflecting from right to left, i.e. switching to a next page for the writing style from left to right. In such a situation, in order to prevent false determination, an extra debug mechanism can be added, and can be based on a deflecting order, user's contact position, etc.

In the prior art, when a user utilizes keypads to switch pages displayed by an electronic book, such kind of operation does not conform to conventional reading styles, and limits user's intention to use. In comparison, the present invention utilizes rotating movements identical or similar to flipping page to control an electronic book to switch pages, such that operations of the electronic book are similar to conventional reading styles, so as to boost user's intention to use.

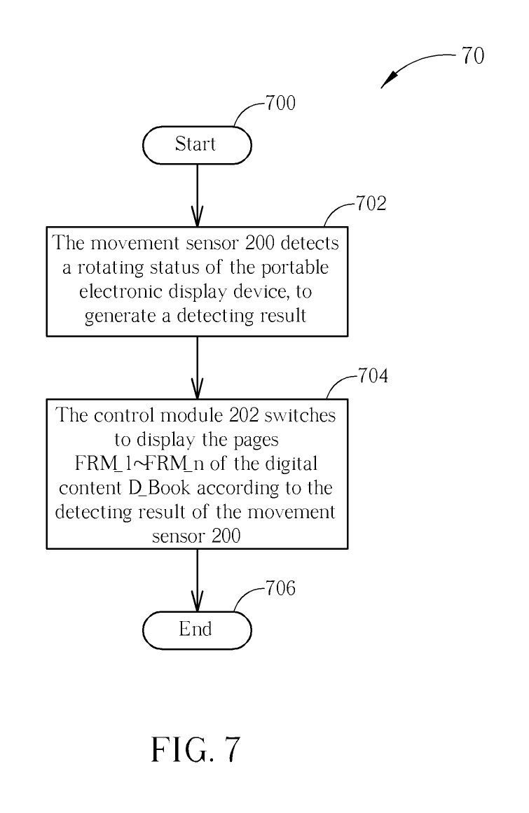

Furthermore, operations of the driving device 20 in FIG. 2 can be summarized into a driving process 70 as shown in FIG. 7. The driving process 70 includes the following steps:

Step 700: Start.

Step 702: The movement sensor 200 detects a rotating status of the portable electronic display device, to generate a detecting result.

Step 704: The control module 202 switches to display the pages FRM_1˜FRM_n of the digital content D_Book according to the detecting result of the movement sensor 200.

Step 706: End.

Detailed operations of the driving process 70 can be referred to the above description, and are not narrated herein.

To sum up, the present invention utilizes rotating movements identical or similar to flipping page to control an electronic book to switch pages, such that operations of the electronic book are similar to conventional reading styles, and thus boost user's intention to use.

Those skilled in the art will readily observe that numerous modifications and alterations of the device and method may be made while retaining the teachings of the invention.

What is claimed is:

1. A driving device for a portable electronic display device capable of showing a digital content, the driving device comprising:
a movement sensor, installed in the portable electronic display device, for detecting a rotating status of the portable electronic display device, to generate a detecting result; and
a control module, for switching to display a plurality of pages of the digital content according to the detecting result.

2. The driving device of claim 1, wherein the movement sensor is a gravitation sensor, for detecting a rotating status of a plane of the portable electronic display device, to generate the detecting result.

3. The driving device of claim 1, wherein the portable electronic display device comprises a flexible panel, and the movement sensor is a deformation sensor, for detecting a deflecting status of the flexible panel, to determine the rotating status of the portable electronic display device and generate the detecting result.

4. The driving device of claim 1, wherein the plurality of pages of the digital content are horizontally arranged in order, and the control module switches the plurality of pages leftward when the detecting result indicates the portable electronic display device rotates counterclockwise.

5. The driving device of claim 1, wherein the plurality of pages of the digital content are horizontally arranged in order, and the control module switches the plurality of pages rightward when the detecting result indicates the portable electronic display device rotates clockwise.

6. A portable electronic display device capable of showing a digital content, comprising:
a panel;
an image processing unit, for showing the digital content via the panel; and
a driving device, comprising:
a movement sensor, for detecting a rotating status of the portable electronic display device, to generate a detecting result; and
a control module, for controlling the image processing unit to switch to display a plurality of pages of the digital content according to the detecting result.

7. The portable electronic display device of claim 6, wherein the movement sensor is a gravitation sensor, for detecting the rotating status of a plane of the portable electronic display device, to generating the detecting result.

8. The portable electronic display device of claim 6, wherein the panel is flexible, and the movement sensor is a deformation sensor, for detecting a deflecting status of the panel, to determine the rotating status of the portable electronic display device and generate the detecting result.

9. The portable electronic display device of claim 6, wherein the plurality of pages of the digital content are horizontally arranged in order, and the control module controls the image processing unit to switch to display the plurality of pages leftward via the panel when the detecting result indicates the portable electronic display device rotates counterclockwise.

10. The portable electronic display device of claim 6, wherein the plurality of pages of the digital content are horizontally arranged in order, and the control module controls the image processing unit to switch to display the plurality of pages rightward via the panel when the detecting result indicates the portable electronic display device rotates clockwise.

11. A portable electronic display device capable of showing a digital content, comprising:
a first panel;
a second panel, installed in a back of the first panel;
an image processing unit, for showing the digital content via the first panel and the second panel; and
a driving device, comprising:
a movement sensor, for detecting a rotating status of the portable electronic display device, to generate a detecting result; and
a control module, for controlling the image processing unit to switch to display a plurality of pages of the digital content according to the detecting result.

12. The portable electronic display device of claim 11, wherein the movement sensor is a gravitation sensor, for detecting the rotating status of the portable electronic display device, to generating the detecting result.

13. The portable electronic display device of claim 11, wherein the first panel and the second panel are flexible, and the movement sensor is a deformation sensor, for detecting deflecting statuses of the first panel and the second panel, to determine the rotating status of the portable electronic display device and generate the detecting result.

14. The portable electronic display device of claim 11, wherein the plurality of pages of the digital content are horizontally arranged in order, and the control module controls the image processing unit to switch to display the plurality of pages leftward via the first panel and the second panel when the detecting result indicates the portable electronic display device rotates counterclockwise.

15. The portable electronic display device of claim 11, wherein the plurality of pages of the digital content are horizontally arranged in order, and the control module controls the image processing unit to switch to display the plurality of pages rightward via the first panel and the second panel when the detecting result indicates the portable electronic display device rotates clockwise.

16. A driving method for a portable electronic display device capable of showing a digital content, the driving method comprising:
detecting a rotating status of the portable electronic display device, to generate a detecting result; and
switching to display a plurality of pages of the digital content according to the detecting result.

17. The driving method of claim 16, wherein the step of detecting the rotating status of the portable electronic display device is detecting a rotating status of a plane of the portable electronic display device, to generate the detecting result.

18. The driving method of claim 16, wherein the portable electronic display device comprises a flexible panel, and the step of detecting the rotating status of the portable electronic display device is detecting a deflecting status of the flexible panel, to determine the rotating status of the portable electronic display device and generate the detecting result.

19. The driving method of claim 16, wherein the plurality of pages of the digital content are horizontally arranged in order, and the step of switching to display the plurality of pages of the digital content according to the detecting result is switching to display the plurality of pages leftward when the detecting result indicates the portable electronic display device rotates counterclockwise.

20. The driving method of claim 16, wherein the plurality of pages of the digital content are horizontally arranged in order, and the step of switching to display the plurality of pages of the digital content according to the detecting result is switching to display the plurality of pages rightward when the detecting result indicates the portable electronic display device rotates clockwise.
